(19) United States
(12) Patent Application Publication
(10) Pub. No.: US 2014/0070454 A1
(43) Pub. Date: Mar. 13, 2014

(54) DIE FOR INSERT MOLDING AND METHOD FOR INSERT MOLDING OF COLLAR

(71) Applicant: Yazaki Corporation, Tokyo (JP)

(72) Inventors: Yoshinori ISHIKAWA, Makinohara-shi (JP); Shinya ONODA, Makinohara-shi (JP)

(73) Assignee: Yazaki Corporation, Tokyo (JP)

(21) Appl. No.: 14/084,808

(22) Filed: Nov. 20, 2013

Related U.S. Application Data
(63) Continuation of application No. PCT/JP2012/064329, filed on Jun. 1, 2012.

(30) Foreign Application Priority Data
Jun. 2, 2011 (JP) 2011-124217

(51) Int. Cl. B29C 45/14

(52) U.S. Cl. CPC B29C 45/14008
USPC 264/279; 425/129.1

(57) ABSTRACT

An insert-molding mold includes a pair of dies that molds a resin product having a collar insert-molded on an inner circumferential surface of a bolt insertion hole therein, and a bush that is adapted to be inserted in the collar. One die of the dies is provided with a bush insertion hole in which the bush is slidably inserted, and the other die is provided with a cavity surrounding the collar. The bush comprises an upper portion having a cross-sectional shape corresponding to an internal cross-sectional shape of the collar, and a lower portion having a cross-sectional shape corresponding to an external cross-sectional shape of the collar, and is elastically urged toward the other die.

### CROSS REFERENCE TO RELATED APPLICATION

This application is a continuation of PCT application No. PCT/JP2012/064329 which was filed on Jun. 01, 2012, based on Japanese Patent Application No. 2011-124217 filed on Jun. 2, 2011, the contents of which are incorporated herein by reference.

### BACKGROUND OF THE INVENTION

1. Technical Field

The present invention relates to an insert-molding mold and a method for inert-molding a collar, and more particularly, a mold used to mold a resin product, in which a collar is insert-molded on an inner circumferential surface of a bolt insertion hole, and a method for insert-molding the collar using the mold.

2. Background Art

When a resin product is fixed to an attachment subject, there is previously known that a threaded portion of a bolt is inserted in a bolt insertion hole of the resin product and the threaded portion is screwed to a threaded hole of the attachment subject, thereby fixing the resin product to the attachment subject. In this case, in order to prevent the bolt insertion hole of the resin product from being damaged by a bolt fastening force, there has been proposed that a hollow circular cylindrical metal collar is insert-molded on an inner circumferential surface of the bolt insertion hole (see JP-A-10-318220). By inserting the threaded portion of the bolt into the collar and then fastening the bolt, a bottom surface of the head of the bolt is contacted to the collar so that the bolt fastening force can be received by the collar, thereby preventing damage of the resin product.

### SUMMARY

However, when a resin product having a collar insert-molded on an inner circumferential surface of a bolt insertion hole therein is molded as in JP-A-10-318220, the collar is positioned in a cavity defined by a pair of dies, a molten resin is injected into the cavity so that the collar is surrounded by the molten resin, and then the resin is solidified, thereby molding the resin product. At this time, there is a case where collars having different heights are used for the same resin products, and in this case, replacing dies to conform to heights of the collars is not preferable in terms of work efficiency and cost.

Meanwhile, considering manufacturing tolerances of the collar and the dies, it is difficult to conform a height of the collar to a dimension between a pair of dies, and thus, for example, if the height of the collar is smaller than a die dimension in a thickness direction of the resin product, the collar is embedded in the resin product so that the bolt fastening force is not directly received by the collar, and therefore, there is a risk that the resin product is damaged. On the other hand, if the height of the collar is larger than the die dimension in the thickness direction of the resin product, the collar is sandwiched at high pressure between the pair of dies upon insert-molding, and therefore, there is a risk that the dies or the collar is damaged.

An object of the present invention is to realize an mold used to inert-mold a collar, which can deal with collars having different heights and also absorb manufacturing tolerances, and thereby to insert-mold the collar.

The above object of the present invention is solved by an insert-molding mold and a method for insert-molding a collar, having the following configurations.

(1) An insert-molding mold, including a pair of dies for molding a resin product having a collar insert-molded on an inner circumferential surface of a bolt insertion hole therein, and a bush adapted to be inserted in the collar; wherein one die of the dies is provided with a bush insertion hole, in which the bush is slidably inserted, and the other die is provided with a cavity surrounding the collar; and wherein the bush includes an upper portion having a cross-sectional shape corresponding to an internal cross-sectional shape of the collar, and a lower portion having a cross-sectional shape corresponding to an external cross-sectional shape of the collar, and is elastically urged toward the other die.

According to the insert-molding mold of the above configuration (1), upon insert-molding a collar, the collar is positioned in the cavity by inserting the bush, which is slidably inserted in the bush insertion hole of the one die and is elastically urged, in the collar and then clamping the other die. In this time, because an elastic urging force is only exerted between the collar and the dies, the collar or the dies can be prevented from being damaged. For example, because the collar or the dies can be inhibited from being damaged even if the collar is formed to be higher (longer) than a length of the bolt insertion hole of the resin product, it is possible to make an end surface of the collar protrude from the resin product and contact to the bolt, and thus a bolt fastening force can be surely received by the collar. Also, differences in height of collars due to manufacturing tolerances or the like can be absorbed because the collars are positioned by the elastic urging force. Meanwhile, the elastic urging force exerted on the bush is set to a magnitude, which does not cause retraction of the bush due to an injection pressure of a molten resin injected in the cavity. In addition, if the elastic urging force is too large, the collar or the dies can be damaged, and for this reason, the elastic urging force is set to a magnitude, which does not cause damage of the collar or the dies.

(2) The insert-molding mold according to the configuration (1), wherein the bush is elastically urged by a spring member inserted in the bush insertion hole.

(3) A method of insert-molding a collar using the insert-molding mold according to the configuration (1) or (2), including inserting the bush in the bush insertion hole of the one die; mounting the collar on the upper portion of the bush; pressing and clamping the other die to the one die while the bush is elastically urged toward the other die; and injecting a molten resin into the cavity, thereby molding the collar.

### BRIEF DESCRIPTION OF DRAWINGS

FIG. 1 is a perspective view of an insert-molding mold and a resin product molded by the mold according to one embodiment of the present invention.

FIG. 2A is a sectional view of the mold, in which dies has been clamped and then a resin has been injected, taken at a location of a line Q-Q in FIG. 1, and FIG. 2B is a view showing a height of a hollow circular cylindrical collar.

FIG. 3A is a perspective view of the resin product of FIG. 1 as viewed from a movable die, FIG. 3B is a perspective view of the resin product of FIG. 1 as viewed form a fixed die, and FIG. 3C is a perspective view of a hollow circular cylindrical collar and a hollow elliptic cylindrical collar.

FIG. 4A is a perspective view of the hollow circular cylindrical collar and a bush, and FIG. 4B is a perspective view showing a state where the bush has been inserted in the hollow circular cylindrical collar.

FIG. 5A is a perspective view of the hollow elliptic cylindrical collar and a bush, and FIG. 5B is a perspective view showing a state where the bush has been inserted in the hollow elliptic cylindrical collar.

FIG. 6 is a perspective view of the fixed die in a state where bushes are inserted in the hollow circular cylindrical collar and the hollow elliptic cylindrical collar.

FIG. 7A is a sectional view, similar to the sectional view of FIG. 2, showing a case where the hollow circular cylindrical collar and the hollow elliptic cylindrical collar having a smaller height are used, and FIG. 7B is a view showing a height of the hollow circular cylindrical collar.

FIG. 8A is a sectional view, similar to the sectional view of FIG. 2, showing a case where the hollow circular cylindrical collar and the hollow elliptic cylindrical collar having a larger height are used, and FIG. 8B is a view showing a height of the hollow circular cylindrical collar.

FIG. 9A is a sectional view, similar to the sectional view of FIG. 2, showing as a comparative example a case where a bush is fixed to a die, and FIG. 9B is a view showing a height of the hollow circular cylindrical collar.

FIG. 10A is a sectional view, similar to the sectional view of FIG. 2, showing as a comparative example a case where a bush is fixed to a die, and FIG. 10B is a view showing a height of the hollow circular cylindrical collar.

### DETAILED DESCRIPTION OF EMBODIMENTS

### Embodiments

The present invention will be now described on the basis of embodiments.

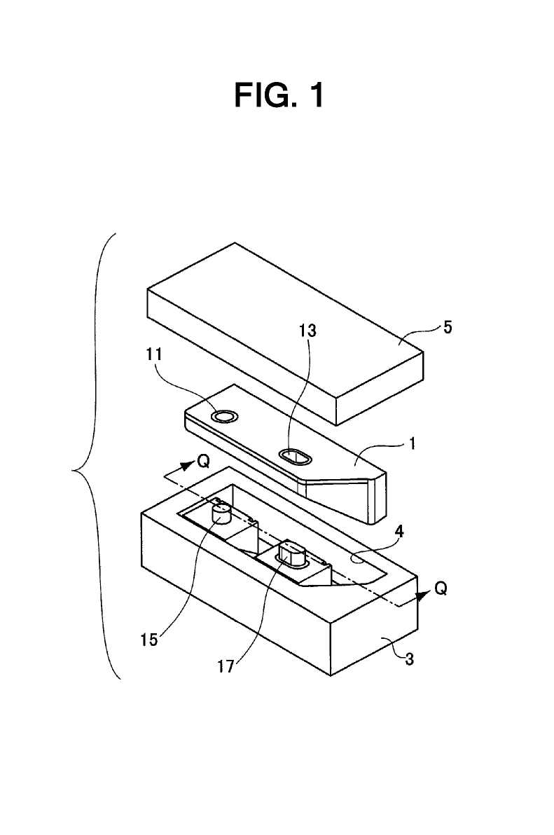

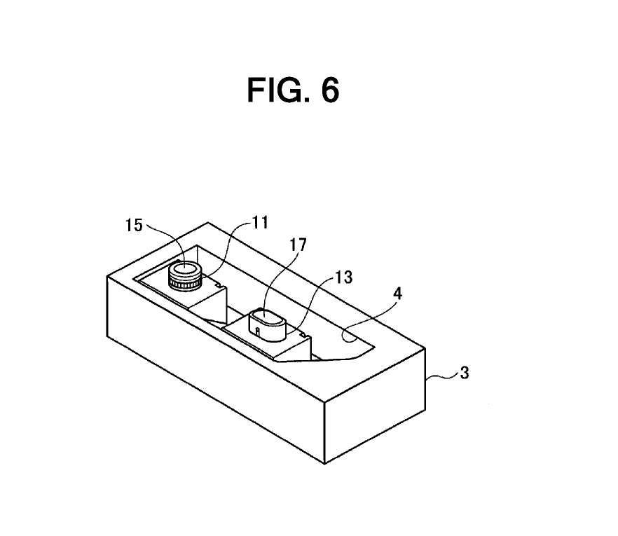

As shown in FIGS. 1 to 6, an insert-molding mold of the present embodiment has a pair of dies 3 and 5 for molding a resin product 1.

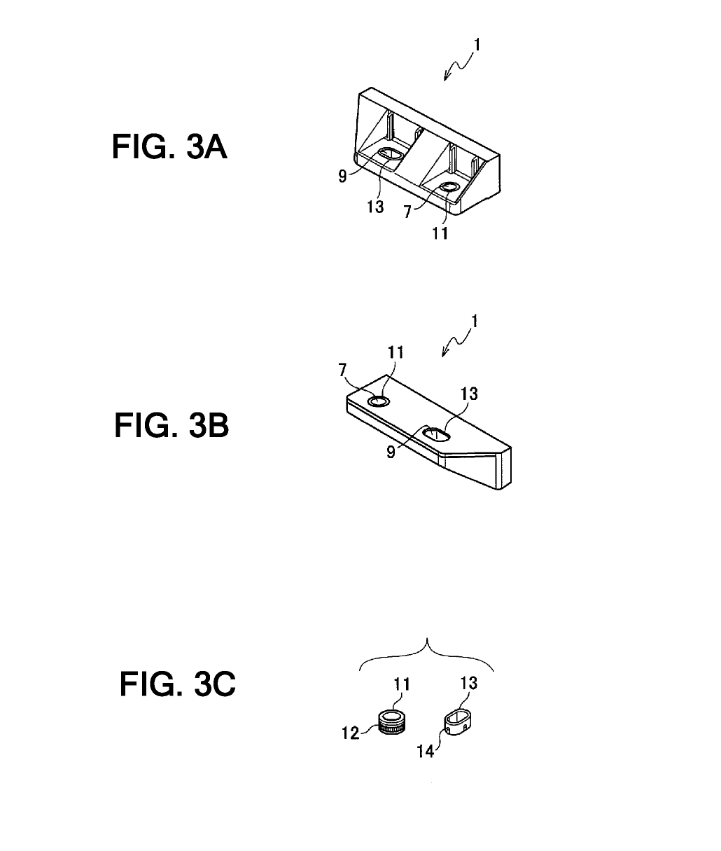

As shown in FIGS. 3A and 3B, the resin product 1 is provided with bolt insertion holes 7 and 9 in which bolts, not shown, are inserted when the resin product 1 is fixed to an attachment subject. The bolt insertion hole 7 is formed in a circular shape, and the bolt insertion hole 9 is formed in an elliptical shape. Metal collars 11 and 13 are insert-molded on inner circumferential surfaces of the bolt insertion holes 7 and 9. The collars 11 and 13 are respectively formed to correspond to internal cross-sectional shapes of the bolt insertion holes 7 and 9. Namely, the collar 11 insert-molded in the circular bolt insertion hole 7 is formed in a hollow circular cylindrical shape, and the collar 13 insert-molded in the elliptical bolt insertion hole 9 is formed in a hollow elliptic cylindrical shape.

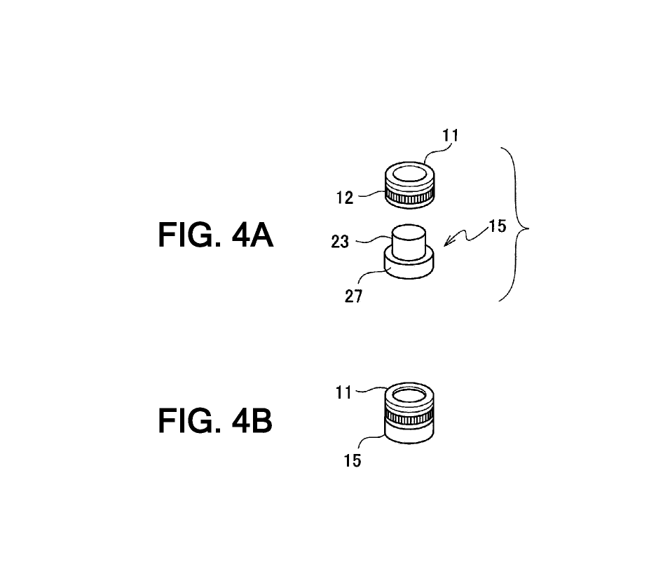

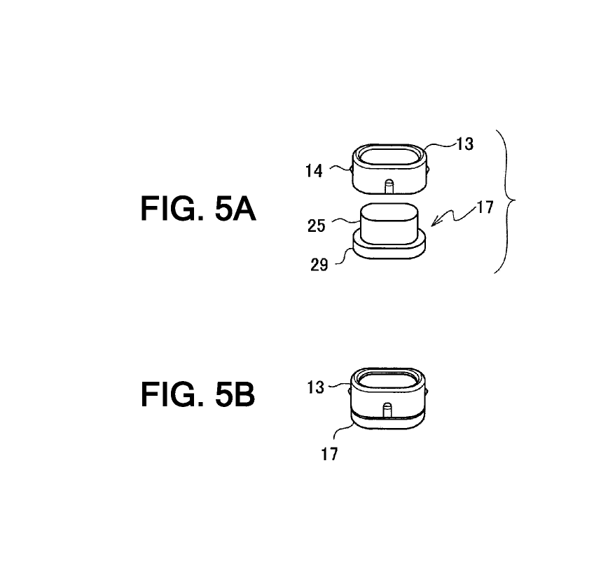

As shown in FIG. 4A, an outer circumferential surface of the collar 11 is provided with an unevenness portion 12 having a plurality of concave and convex parts alternately formed therein. As shown in FIG. 5A, an outer circumferential surface of the collar 13 is provided with a plurality of convex portions 14. By solidifying a resin along shapes of the unevenness portion 12 and the convex portions 14, the collars 11 and 13 are configured to be prevented from being detached from the resin product 1.

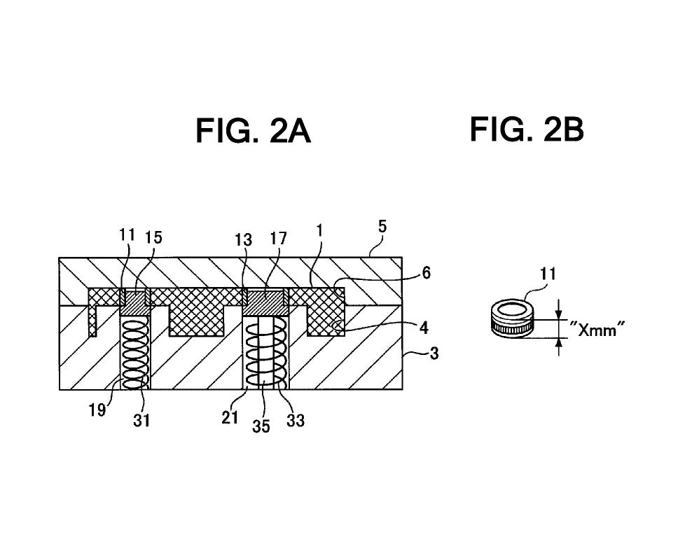

As shown in FIG. 2A, the pair of dies 3 and 5 are constituted of the die 3, which is a fixed die, and the die 5, which is a movable die, and are clamped at a die clamping force set by a molding machine, not shown. The dies 3 and 5 are respectively provided therein with cavities 4 and 6, into which a molten resin is injected, and the cavities 4 and 6 are formed to correspond to a shape of the resin product 1 by pressing and clamping the opposing die 5 to the fixed die 3. On either one of the dies 3 and 5, a gate, not shown, allowing the molten resin to be injected into the cavities 4 and 6 is provided.

The fixed die 3 is provided therein with bush insertion holes 19 and 21, into each of which bushes 15 and 17 are respectively slidably inserted. The bushes 15 and 17 are respectively provided with upper portions 23 and 25, which are respectively inserted in the collars 11 and 13, and lower portions 27 and 29, which are connected to the upper portions 23 and 25 and bear the inserted collars 11 and 13. As shown in FIG. 4A, the upper portion 23 of the bush 15 is formed in a circular column shape corresponding to an internal cross-sectional shape of the hollow circular cylindrical collar 11, and the lower portion 27 thereof is formed in a circular disk shape corresponding to an external cross-sectional shape of the hollow circular cylindrical collar 11. As shown in FIG. 5A, the upper portion 25 of the bush 17 is formed in an elliptic column shape corresponding to an internal cross-sectional shape of the hollow elliptic cylindrical collar 13, and the lower portion 29 thereof is formed in an elliptic disk shape corresponding to an external cross-sectional shape of the hollow elliptic cylindrical collar 13. The bush insertion hole 19 is dimensioned such that an inner circumferential surface thereof is slidably contacted to an outer circumferential surface of the lower portion 27 of the bush 15. The bush insertion hole 21 is dimensioned such that an inner circumferential surface thereof is slidably contacted to an outer circumferential surface of the lower portion 29 of the bush 17.

The bush insertion holes 19 and 21 are respectively formed to allow spring member 31 and 33, each of which elastically urges each of the bushes 15 and 17 toward the die 5, to be inserted therein. Each of the spring members 31 and 33 is supported by a driving device, not shown, and is adapted to advance into and retreat from each of the bush insertion holes 19 and 21. One end of each of the spring members 31 and 33 is supported by the driving device and the other end thereof is connected or contacted to each of the lower portions 27 and 29 of the bushes 15 and 17. According to the present embodiment, the one end of the spring member 31 inserted in the bush insertion hole 19 is connected to the driving device and the other end thereof is connected to the lower portion 17 of the bush 15. On the other hand, a rod 35 provided to stand on the driving device is inserted in the spring member 33 inserted in the bush insertion hole 21, and thus the one end of the spring member 33 is contacted to the driving device and the other end thereof is contacted to the lower portion 29 of the bush 17. Therefore, by pressing each of the spring members 31 and 33 respectively into each of the bush insertion holes 19 and 21 by the driving device, each of the bushes 15 and 17 is elastically urged toward the die 5. However, similarly to the spring member 33, the spring member 31 may be supported on the driving device by the rod 35. Also, similarly to the spring member 31, the spring member 33 is not provided with the rod 33, but may be provided to be continuous to and to be supported by the driving device. Further, the bush 17 may be provided to be continuous to a distal end of the rod 35 via the spring member 33. In brief, any configurations of allowing the bushes 15 and 17 to be elastically urged toward the die 5 by the spring members 31 and 33 can be appropriately selected.

Operations of the insert-molding mold of the present embodiment configured as described above will be described according to a method of molding the resin product 1.

Each of the bushes 15 and 17 is inserted into each of the bush insertion holes 19 and 21 of the die 3, and then each of the spring members 31 and 33 is inserted into each of the bush insertion holes 19 and 21 to be contacted to each of the lower portions 27 and 29 of the bushes. In this time, the bushes 15 and 17 are inserted such that each of the upper portions 23 and 25 thereof protrudes from the bush insertion holes 19 and 21 and is elastically urged by each of the spring member 31 and 33. Each of the protruded upper portions 23 and 25 is inserted into each of hollow portions of the collars 11 and 13, so that one end surface of each of the collars 13 and 15 is contacted to a top surface of each of the lower portions 27 and 29. Therefore, each of the upper portions 23 and 25 of the bushes 15 and 17 is mounted in each of the collars 11 and 13. In this state, by closing the die 3 and the die 5 at the set die clamping force by the molding machine, the cavities 4 and 6 for the resin product 1 surrounding each of the collars 11 and 13 are formed. In this time, each of the collars 11 and 13 is urged by each of the spring members 31 and 33, and the other end surface of each of the collars 11 and 13 is contacted to and positioned on the die 5, so that each of the collars 11 and 13 is held in the cavities 4 and 6.

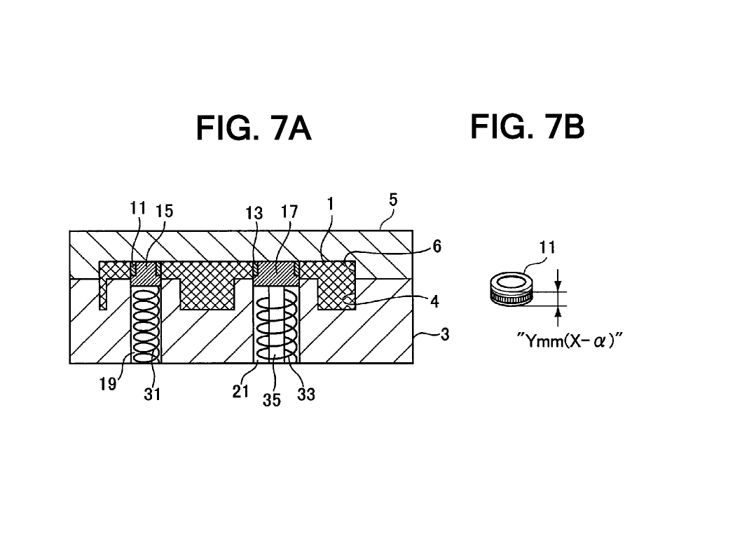

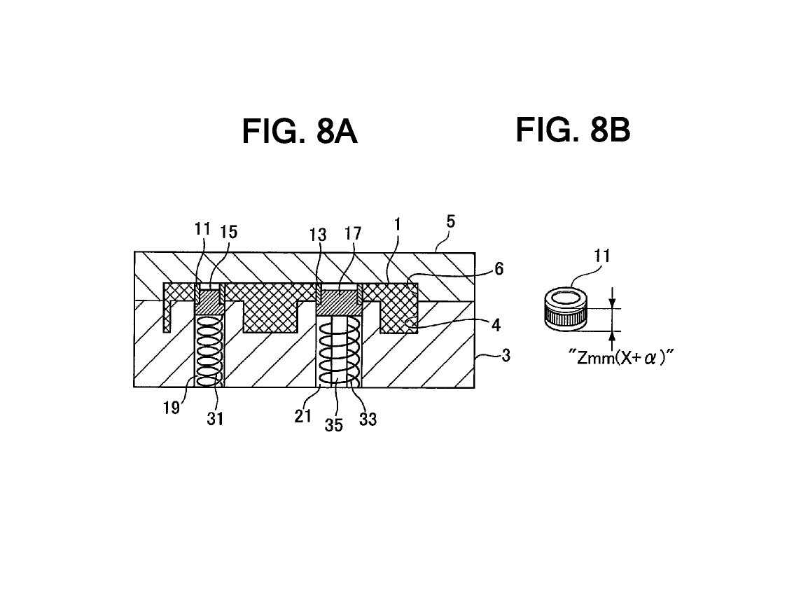

Here, as shown in FIGS. 2A and 2B, when a height of each of the collars 11 and 13 is equal to a thickness of the resin product 1 of X mm, a dimension from a top surface of each of the lower portions 27 and 29 of the bushes 15 and 17 to the die 5 (a dimension in a thickness direction of the resin product 1) corresponds to the thickness of the resin product 1 of X mm. On the one hand, as shown in FIGS. 7A and 7B, when a height of each of the collars 11 and 13 of Y mm is smaller than the thickness of the resin product 1 of X mm by α, the dimension from the top surface of each of the lower portions 27 and 29 of the bushes 15 and 17 to the die 5 corresponds to the height of each of the collars 11 and 13 of Y mm. On the other hand, as shown in FIGS. 8A and 8B, when a height of each of the collars 11 and 13 of Z mm is larger than the thickness of the resin product 1 of X mm by α, the dimension from the top surface of each of the lower portions 27 and 29 of the bushes 15 and 17 to the die 5 corresponds to the height of each of the collars 11 and 13 of Z mm.

In other words, according to the insert-molding mold of the present embodiment, because each of the collars 11 and 13 is positioned by each of the bushes 15 and 17, which is slidably inserted into each of the bush insertion holes 19 and 21 of the die 3 and is elastically urged, it is possible to make a die dimension in the thickness direction of the resin product 1 at a location of each of the collars 11 and 13 correspond to the height of each of the collars 11 and 13.

In this way, after the movable die 5 is pressed and clamped to the fixed die 3, a molten resin is injected into the cavities 4 and 6 through the gate, not shown. Therefore, as the molten resin is covered and solidified on the outer circumferential surface of each of the collars 11 and 13, the bolt insertion holes 7 and 9, in each of which each of the collars 11 and 13 is insert-molded, are molded. In this time, because the molten resin enters the unevenness portion 12 on the outer circumferential surface of the collar 11 and is solidified, the collar 11 can be inhibited from being separated from the bolt insertion hole 7. Also, because the molten resin surrounds the convex portions 14 on the outer circumferential surface of the collar and is solidified, the collar 13 can be inhibited from being separated from the bolt insertion hole 9.

According to the present embodiment, upon insert-molding, each of the collars 11 and 13 is sandwiched and positioned between the die 5 and the bushes 15 and 17 by an elastic urging force of each of the spring members 31 and 33. Namely, because the elastic urging force smaller than the die clamping force is only exerted on the each of the collars 11 and 13, each of the collars 11 and 13 can be prevented from being damaged due to clamping of the dies 3 and 5. As a result, the collars 11 and 13 each having a height larger than a thickness of the resin product 1 can be used, and thus it is possible to make end surfaces of the collars 11 and 13 be surely exposed on a surface of the resin product 1. Therefore, a bolt fastening force when the resin product 1 is attached to the attachment subject can be directly received by each of the collars 11 and 13.

Further, because the collars 11 and 13 can be positioned by elongating or contracting the spring members 31 and 33 depending upon heights of the collars 11 and 13, collars having heights variable according to manufacturing tolerances can be used.

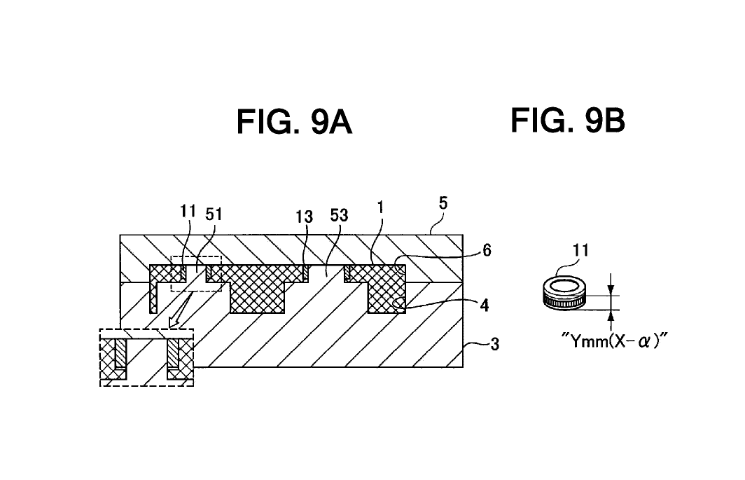

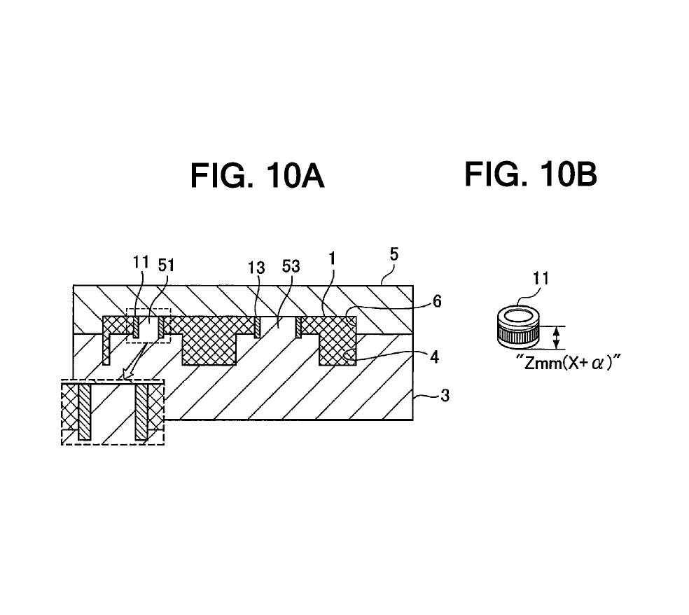

Contrarily, as shown in comparative examples of FIGS. 9 and 10, when each of the collars 11 and 13 is positioned by convex portions 51 and 53 formed on the die 3, the collars 11 and 13 having different heights cannot be used. For example, as shown in FIG. 9, when a height of each of the collars 11 and 13 of Y mm is smaller than the thickness of the resin product 1 of X mm by α, the height of each of the collars 11 and 13 becomes smaller than the die dimension in the thickness direction of the resin product 1, and as a result, the end surface of each of the collars 11 and 13 is not covered with the resin, so that a bolt fastening force cannot be directly received by each of the collars 11 and 13. In addition, as shown in FIG. 10, when a height of each of the collars 11 and 13 of Z mm is larger than the thickness of the resin product 1 of X mm by α, the height of each of the collars 11 and 13 becomes larger than the die dimension in the thickness direction of the resin product 1, and thus, each of the collars 11 and 13 is sandwiched at high pressure between the dies 3 and 5 due to the die clamping force, and as a result, there is a risk that the dies 3 and 5 or each of the collars 11 and 15 is damaged.

Meanwhile, as in the present embodiment, if the each of the collars 11 and 13 is held by each of the bushes 15 and 17, which is slidably inserted into each of the bush insertion holes 19 and 21 of the die 3 and is elastically urged, there is a risk that the bushes 15 and 17 are retracted in a direction away from the die 3 due to an injection pressure of the molten resin injected in the cavities 4 and 6. For this reason, the spring members having an elastic repulsive force greater than the injection pressure of the molten resin are used. However, if the elastic urging force is too large, the dies 3 and 5 or the collars 11 and 13 are damaged, and for this reason, the spring members having an elastic repulsive force of a degree, in which the dies 3 and 5 or the collars 11 and 13 are not damaged, are used.

Meanwhile, the present invention is not limited to the foregoing embodiment, but appropriate changes, modifications or the like thereof can be made. In addition, material, shape, dimension, number, installation position and the like of each of the components of the foregoing embodiment are not limited but arbitrary as long as the present invention can be achieved.

According to an insert-molding mold based on the present invention, a mold, which can deal with collars having different heights and also absorb manufacturing tolerances, can be realized and the collars can be insert-molded.

### Reference Signs List

1 Resin product
3, 5 Die
4, 6 Cavity
7, 9 Bolt insertion hole
11, 13 Collar
15, 17 Bush
19, 21 Bush insertion hole
23, 25 Upper portion
27, 29 Lower portion
31, 33 Spring member

What is claimed is:

1. An insert-molding mold, comprising:
a pair of dies that molds a resin product having a collar insert-molded on an inner circumferential surface of a bolt insertion hole therein; and
a bush that is adapted to be inserted in the collar,
wherein one die of the dies is provided with a bush insertion hole in which the bush is slidably inserted, and the other die is provided with a cavity surrounding the collar; and
wherein the bush comprises an upper portion having a cross-sectional shape corresponding to an internal cross-sectional shape of the collar, and a lower portion having a cross-sectional shape corresponding to an external cross-sectional shape of the collar, and is elastically urged toward the other die.

2. The insert-molding mold according to claim 1, wherein the bush is elastically urged by a spring member inserted in the bush insertion hole.

3. A method of insert-molding a collar using the insert-molding mold according to claim 1, comprising:
inserting the bush in the bush insertion hole of the one die;
mounting the collar on the upper portion of the bush;
pressing and clamping the other die to the one die while the bush is elastically urged toward the other die; and
injecting a molten resin into the cavity to mold the collar.

4. The method of insert-molding the collar according to claim 3, wherein the bush is elastically urged by a spring member inserted in the bush insertion hole.
